(19) United States
(12) Patent Application Publication
(10) Pub. No.: US 2025/0351811 A1
(43) Pub. Date: Nov. 20, 2025

(54) System and Method to Reduce Power Consumption of a Pulse Width Modulation Valve During Fluid Application

(71) Applicant: Precision Planting LLC, Tremont, IL (US)

(72) Inventor: Dillon Sloneker, Danvers, IL (US)

(21) Appl. No.: 18/869,207

(22) PCT Filed: Mar. 15, 2023
(86) PCT No.: PCT/IB2023/052494

§ 371 Date: Nov. 25, 2024

Related U.S. Application Data
(60) Provisional application No. 63/365,525, filed on May 31, 2022.

(51) Int. Cl. A01M 7/00; B05B 1/08; B05B 12/08; F16K 31/06

(52) U.S. Cl. CPC A01M 7/0089; B05B 1/083; B05B 12/082; F16K 31/0675

(57) ABSTRACT

In an aspect, there is provided a method of operating a pulse width modulation (PWM) valve for a fluid application of an agricultural implement. The method includes applying full current for a first period of time to fully open the PWM valve, applying a reduced current for a reduced current value that is from 0 up to a dissipating threshold value that is below full current for a second period of time to rapidly dissipate energy in the PWM valve that is fully open, and applying a holding current for a third period of time to hold the PWM valve fully open for the fluid application.

### CROSS-REFERENCE TO RELATED APPLICATION

This application claims priority to U.S. Provisional Application No. 63/365,525, filed on 31 May 31 2022 entitled: SYSTEM AND METHOD TO REDUCE POWER CONSUMPTION OF A PULSE WIDTH MODULATION VALVE DURING FLUID APPLICATION, the entire contents of which are hereby incorporated by reference.

### FIELD

Embodiments of the present disclosure relate generally to a system and method to reduce a current draw and power consumption during a fluid application of a pulse width modulation (PWM) valve.

### BACKGROUND

Sprayers and other fluid application systems are used to apply fluids (such as fertilizer, herbicide, insecticide, and/or fungicide) to fields. The sprayers and other fluid application systems operating in agricultural fields to apply fluids can require a significant amount of current during a fluid application for a sprayer or other fluid application systems having a large number of PWM valves.

### BRIEF SUMMARY

In an aspect of the disclosure there is provided a method of operating a pulse width modulation (PWM) valve for a fluid application. The method includes applying full current for a first period of time to fully open the PWM valve, applying a reduced current for a reduced current value that is from 0 up to a dissipating threshold value that is below full current for a second period of time to rapidly dissipate energy in the PWM valve that is fully open, and applying a holding current for a third period of time to hold the PWM valve fully open for the fluid application. Applying the reduced current for the second period of time to rapidly dissipate energy in the PWM valve results in reduced current draw and reduced power consumption (e.g., 10-20% reduction in power consumption) for operation of the PWM valve.

In one example of this method, the reduced current value is 0 to 20% of a full current value. In another example of this method, the reduced current value is 5% to 15% of the full current value. In another example of this method, the reduced current value is 8% to 12% of the full current value.

In one example of this method, the second period of time is 0.20 milliseconds to 2.0 milliseconds.

In one example of this method, the second period of time is 1.0 milliseconds to 1.5 milliseconds.

In one example of this method, the holding current is designed as a minimum current to hold the PWM valve fully open for the fluid application. In one example of this method, the holding current for a holding current value is 70% to 80% of the full current value.

In one example, this method further includes generating a first PWM signal having a first duty cycle for the reduced current and generating a second PWM signal having a second duty cycle for holding current.

A further aspect of the disclosure provides a fluid application system that includes a pulse width modulation (PWM) valve disposed on an implement and a controller coupled to the PWM valve. The controller is configured to apply full current for a first period of time to fully open the PWM valve, to apply a reduced current for a reduced current value that is from 0 up to a dissipating threshold value that is below full current for a second period of time to rapidly dissipate energy in the PWM valve that is fully open, and to apply a holding current for a third period of time to hold the PWM valve fully open for a fluid application to a field

In one example, this fluid application system further includes additional PWM valves disposed along a boom of the implement or disposed on each row unit of the implement and a plurality of nozzles disposed along the boom of the implement or disposed on each row unit of the implement.

In one example of this fluid application system, each nozzle is connected to or integrated with a PWM valve to spray the fluid application from each nozzle.

In one example of this fluid application system, the reduced current value is 0 to 20% of a full current value.

In one example of this fluid application system, the reduced current value is 5% to 15% of the full current value.

In one example of this fluid application system, the reduced current value is 8% to 12% of the full current value.

In one example of this fluid application system, the second period of time is 0.20 milliseconds to 2.0 milliseconds.

In one example of this fluid application system, the second period of time is 1.0 milliseconds to 1.5 milliseconds.

In one example of this fluid application system, the holding current is designed as a minimum current to hold the PWM valve fully open for the fluid application.

In one example of this fluid application system, the holding current for a holding current value is 70% to 80% of the full current value.

In one example of this fluid application system, the controller is further configured to generate a first PWM signal having a first duty cycle for the reduced current and to generate a second PWM signal having a second duty cycle for the holding current.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the disclosure will now be described, by way of example only, with reference to the accompanying drawings, in which:

FIG. 1 is an illustration of an agricultural crop sprayer;

FIG. 2 is a rear elevation view of a fluid application system with cameras and lights according to one embodiment;

FIG. 3 is a rear elevation view of a fluid application system with cameras and lights according to one embodiment;

FIGS. 4 and 5 illustrate a spray pattern 55 from a nozzle 50c of valve and nozzle assembly 50 in accordance with one embodiment;

FIG. 6 illustrates a flow diagram of one embodiment for a computer-implemented method of operating a pulse width modulation (PWM) valve for a fluid application for fluid being applied to a field by an implement;

FIG. 7 illustrates a timing diagram 700 for signals of a PWM valve;

FIG. 8 illustrates a timing diagram 800 for signals of a PWM valve to reduce power consumption in accordance with one embodiment;

FIG. 9 shows an example of a block diagram of an implement 140 (e.g., sprayer, spreader, irrigation implement, etc.) in accordance with one embodiment; and

FIG. 10 shows an example of a block diagram of a system 100 that includes a machine 102 (e.g., tractor, combine harvester, etc.) and an implement 1240 (e.g., planter, cultivator, plough, sprayer, spreader, irrigation implement, etc.) in accordance with one embodiment.

FIG. 11 illustrates a timing diagram 1100 for signals of a PWM valve; and

FIG. 12 illustrates a timing diagram 1200 for signals of a PWM valve to reduce current draw and reduce power consumption in accordance with one embodiment.

### DETAILED DESCRIPTION

All references cited herein are incorporated herein in their entireties. If there is a conflict between a definition herein and in an incorporated reference, the definition herein shall control.

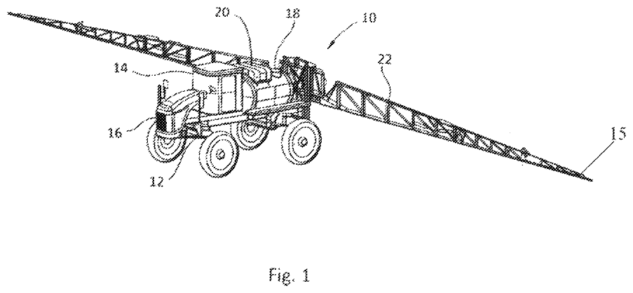

Referring to the drawings, wherein like reference numerals designate identical or corresponding parts throughout the several views, FIG. 1 illustrates an agricultural implement, such as a sprayer 10. While the system 15 can be used on a sprayer, the system 15 can be used on any agricultural implement that is used to apply fluid to soil, such as a side-dress bar, a planter, a seeder, an irrigator, a center pivot irrigator, a tillage implement, a tractor, a cart, or a robot. A reference to boom or boom arm herein includes corresponding structures, such as a toolbar, in other agricultural implements.

FIG. 1 shows an agricultural crop sprayer 10 used to deliver chemicals to agricultural crops in a field. Agricultural sprayer 10 comprises a chassis 12 and a cab 14 mounted on the chassis 12. Cab 14 may house an operator and a number of controls for the agricultural sprayer 10. An engine 16 may be mounted on a forward portion of chassis 12 in front of cab 14 or may be mounted on a rearward portion of the chassis 12 behind the cab 14. The engine 16 may comprise, for example, a diesel engine or a gasoline powered internal combustion engine. The engine 16 provides energy to propel the agricultural sprayer 10 and also can be used to provide energy used to spray fluids from the sprayer 10.

Although a self-propelled application machine is shown and described hereinafter, it should be understood that the embodied invention is applicable to other agricultural sprayers including pull-type or towed sprayers and mounted sprayers, e.g., mounted on a 3-point linkage of an agricultural tractor.

The sprayer 10 further comprises a fluid storage tank 18 used to store a spray fluid to be sprayed on the field. The spray fluid can include chemicals, such as but not limited to, herbicides, pesticides, and/or fertilizers. The fluid can be a substance such as a liquid or gas that is capable of flowing and changing its shape when acted upon by a force. Fluid storage tank 18 is to be mounted on chassis 12, either in front of or behind cab 14. The crop sprayer 10 can include more than one storage tank 18 to store different chemicals to be sprayed on the field. The stored chemicals may be dispersed by the sprayer 10 one at a time or different chemicals may be mixed and dispersed together in a variety of mixtures. The sprayer 10 further comprises a rinse water tank 20 used to store clean water, which can be used for storing a volume of clean water for use to rinse the plumbing and main tank 18 after a spraying operation.

At least one boom arm 22 on the sprayer 10 is used to distribute the fluid from the fluid tank 18 over a wide swath as the sprayer 10 is driven through the field. The boom arm 22 is provided as part of a fluid application system 15 as illustrated in FIGS. 1-3, which further comprises an array of spray nozzles (in addition to lights, cameras, and processors described later) arranged along the length of the boom arm 22 and suitable sprayer plumbing used to connect the fluid storage tank 18 with the spray nozzles. The sprayer plumbing will be understood to comprise any suitable tubing or piping arranged for fluid communication on the sprayer 10. Boom arm 22 can be in sections to permit folding of the boom arm for transport.

Additional components that can be included, such as control modules or lights, are disclosed in PCT Publication No. WO2020/178663 and U.S. Application No. 63/050,314, filed 10 Jul. 2020, respectively.

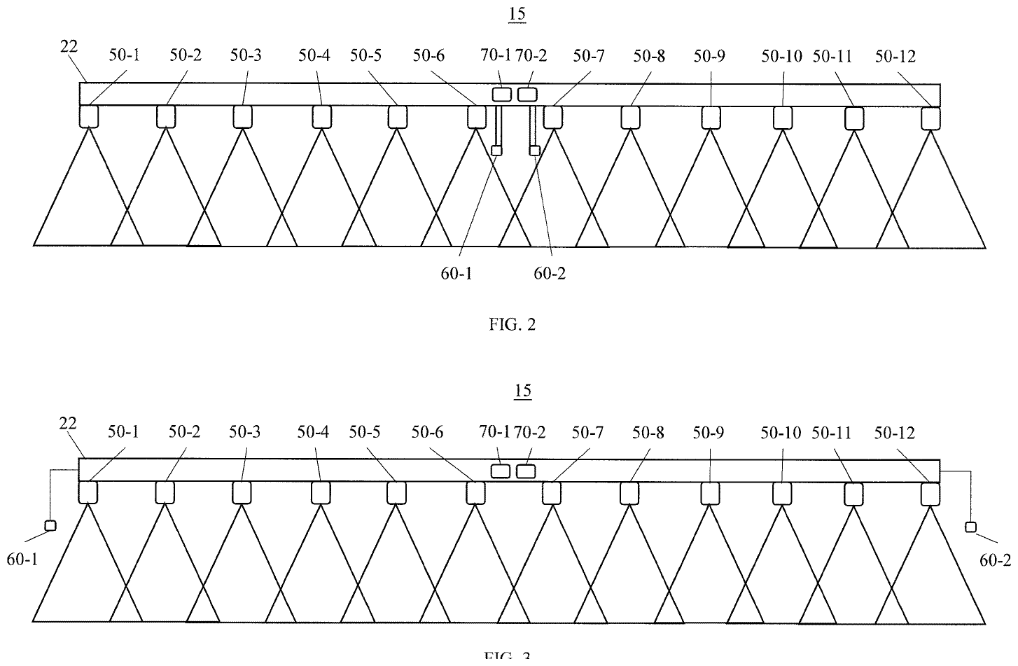

Illustrated in FIGS. 2 to 3, there are a plurality of valve and nozzle assemblies 50 (50-1 to 50-12) disposed on boom arm 22. While illustrated with 12 valve and nozzle assemblies 50, there can be any number (e.g., 2 to 200) of valve and nozzle assemblies 50 disposed on boom arm 22. Each valve and nozzle assembly 50 includes a PWM valve (e.g., PWM solenoid valve) that is controlled by a PWM circuit and a nozzle to dispense a fluid or material (such as fertilizer, herbicide, or pesticide) in a spray. In any of the embodiments, a pulse width modulation (PWM) actuator (e.g., PWM valve, PWM solenoid valve) and nozzle assembly turns the nozzle on and off by opening or closing the nozzle. In one example, the PWM valve drives to a specified position (e.g., full open position, full closed position) according to a pulse duration, which is a length of the signal.

Pulse width modulation (PWM) is a method of reducing the average power delivered by an electrical signal, by breaking the electrical signal up into predefined pulses. When utilized to operate direct acting solenoid valves, a PWM signal can result in significant power saving and heat reduction while maintaining the desired pneumatic function.

Illustrated in FIGS. 2 to 3, there are two cameras 70 (70-1 and 70-2) disposed on the boom arm 22 with each camera 70-1 and 70-2 disposed to view half of the boom arm 22.

FIG. 2 illustrates two lights 60 (60-1, 60-2) that are disposed at a middle (24) of the boom arm 22 and disposed to each illuminate towards ends (23, 25) of boom arm 22.

FIG. 3 illustrates two lights 60 (60-1, 60-2) that are disposed at the ends (23, 25) of boom arm 22 and disposed to illuminate towards the middle (24) of boom arm 22.

In any of the embodiments, camera 70 can be coordinated with the PWM of the valve and nozzle assemblies 50. In one embodiment, camera 70 can capture images when the valve and nozzle assembly 50 is off and when the valve and nozzle assembly 50 is on. In one embodiment, a configurable parameter for the spraying frequency is 5 to 20 Hz causing a PWM valve for a nozzle to open 5 to 20 times per second to apply fluid during those open times. In one example, the configurable parameter for the spraying frequency is 10 to 15 Hz causing a PWM valve for the nozzle to open 5 to 20 times per second to apply fluid during those open times.

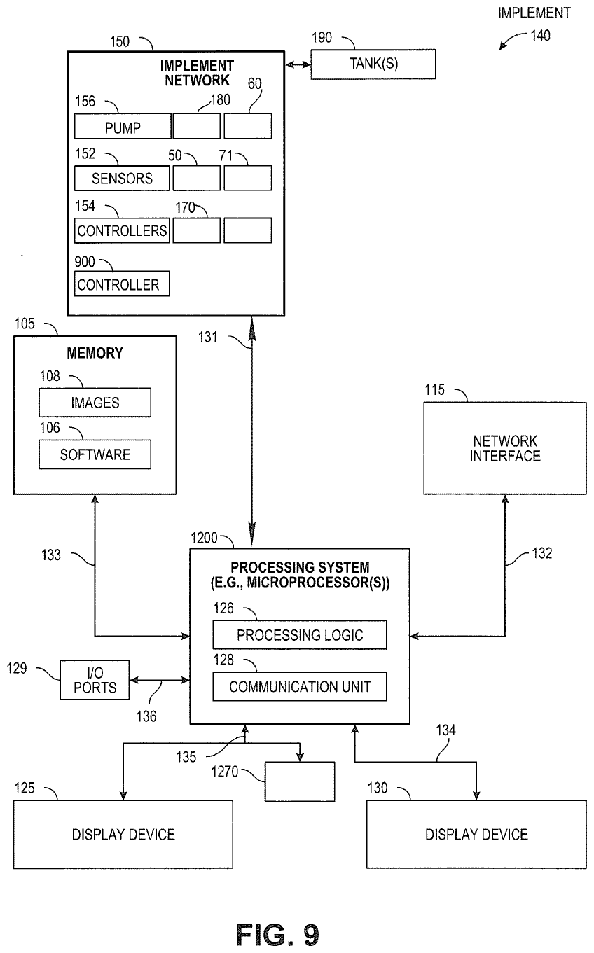

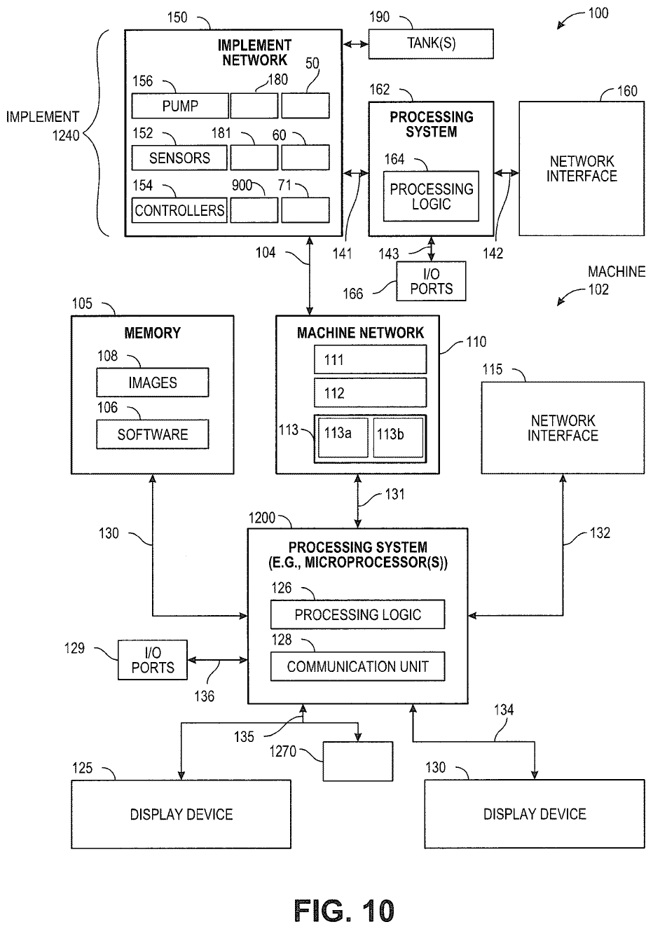

In one embodiment, valve and nozzle assemblies 50, lights 60, and cameras 70 are connected to a network. An example of a network is described in PCT Publication No. WO2020/039295A1 and is illustrated as implement network 150 in FIGS. 9 and FIG. 10.

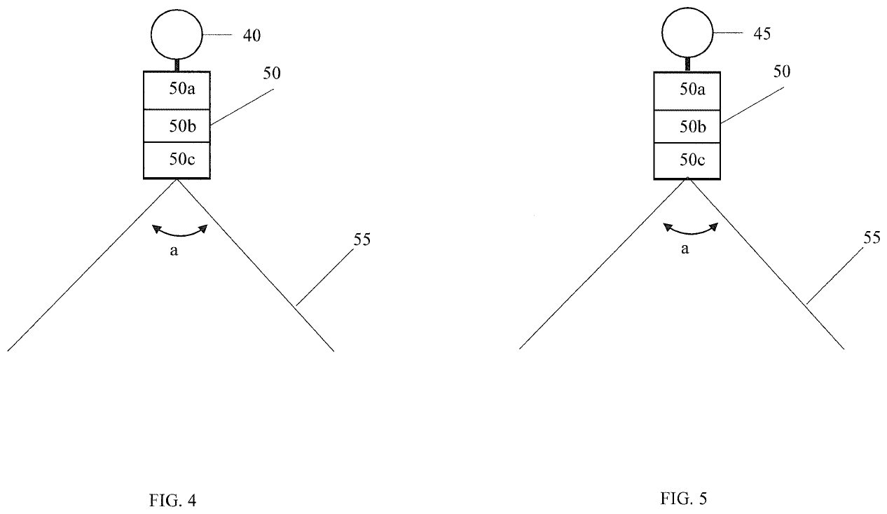

FIGS. 4 and 5 illustrate a spray pattern 55 from a nozzle 50c of valve and nozzle assembly 50 having a spray angle (a). The valve and nozzle assembly 50 is shown with a controller 50a to control operations of a PWM valve 50b, and a nozzle 50c. In some embodiment, the valve 50b is mounted or connected to the nozzle 50c or formed integrally with the nozzle 50c.

Spray pattern 55 can be captured in an image from camera 70. The image can be analyzed (e.g., analyzed with artificial intelligence) to determine pattern, uniformity, spray angle (a), and amount of light refracted. In FIG. 4, optional pressure sensor 40 can be installed anywhere before valve and nozzle assembly 50. In FIG. 5, optional flow meter 45 can be installed anywhere between valve and nozzle assembly 50 and the fluid source.

Spray angle (a) is a function of nozzle tip geometry, material viscosity, PWM duty cycle, pressure, and flow rate. For a given nozzle spraying a material under a specific duty cycle, these parameters are fixed. Any variation in spray angle (a) is related to changes in pressure or flow rate with one of these being fixed.

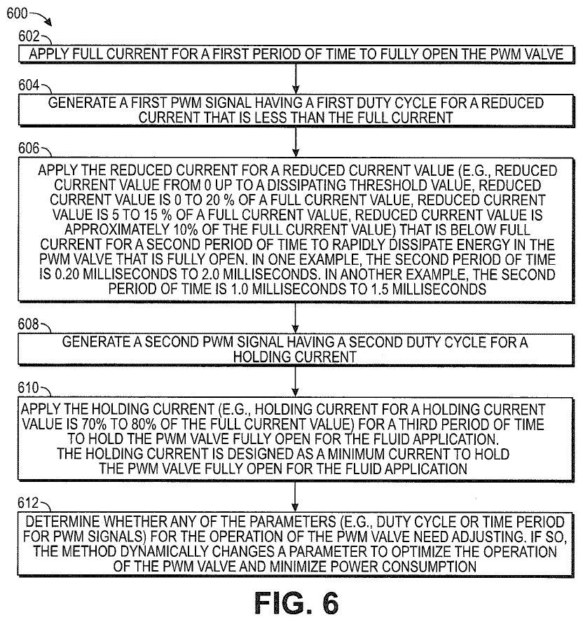

FIG. 6 illustrates a flow diagram of one embodiment for a computer-implemented method of operating a pulse width modulation (PWM) valve for a fluid application for fluid being applied to a field by an implement. The method 600 is performed by processing logic that may comprise hardware (a controller, circuitry, PWM circuitry, dedicated logic, a processor, etc.), software (such as is run on a general purpose computer system or a dedicated machine or a device), or a combination of both. In one embodiment, the method 600 is performed by a controller (e.g., controller 50a to operate valve 50b, controllers 154) or processing logic (e.g., processing logic 126, 164) of a processing system. The camera can be attached to a boom as described herein. A current or current level are interchangeable terms as described herein. The method 600 can be applied to a PWM valve as described below or a large number of PWM valves arranged along an agricultural implement that traverses rows of crops in a field.

At operation 602, the computer-implemented method applies full current (full current level) for a first period of time (e.g., 5 to 15 milliseconds) to fully open the PWM valve. At operation 604, the computer-implemented method generates a first PWM signal having a first duty cycle for a reduced current (reduced current level) that is less than the full current. At operation 606, the computer-implemented method applies the reduced current for a reduced current value (e.g., reduced current value from 0 up to a dissipating threshold value, reduced current value is 0 to 20% of a full current value, reduced current value is 5 to 15% of a full current value, reduced current value is approximately 10% of the full current value) that is below full current for a second period of time to rapidly dissipate energy in the PWM valve (e.g., solenoid) that is fully open. In one example, the dissipating threshold value can be 10% to 20% of a full current value. The solenoid valve naturally stores energy from being charged during the first period of time with full current being applied. The reduced current is designed to have a low duty cycle for a brief time period to rapidly discharge the solenoid coil (instead of waiting for a slow discharge decay of the solenoid coil if a PWM signal with a higher duty cycle (e.g., 50 to 100% is being applied)) while still maintaining the valve in a fully open position. In one example, the second period of time is 0.20 milliseconds to 2.0 milliseconds. In another example, the second period of time is 1.0 milliseconds to 1.5 milliseconds.

At operation 608, the computer-implemented method generates a second PWM signal having a second duty cycle for a holding current (holding current level). At operation 610, the computer-implemented method applies the holding current (e.g., holding current for a holding current value is 70% to 80% of the full current value) for a third period of time to hold the PWM valve fully open for the fluid application. The holding current is designed as a minimum current level to hold the PWM valve fully open for the fluid application and minimize power consumption.

At optional operation 612, the computer-implemented method determines whether any of the parameters (e.g., duty cycle or time period for any of the PWM signals, time period of non-PWM signals, etc.) for the operation of the PWM valve need adjusting. If so, the method dynamically changes a parameter to optimize the operation of the PWM valve and minimize power consumption. In one example, a power consumption signal (e.g., signal 812) is monitored to determine whether any parameter should be adjusted. A peak of the power consumption signal indicates that the PWM valve is fully open.

Although the operations in the computer-implemented methods disclosed herein are shown in a particular order, the order of the actions can be modified. Thus, the illustrated embodiments can be performed in a different order, and some operations may be performed in parallel. Some of the operations listed in the methods disclosed herein are optional in accordance with certain embodiments. The numbering of the operations presented is for the sake of clarity and is not intended to prescribe an order of operations in which the various operations must occur. Additionally, operations from the various flows may be utilized in a variety of combinations.

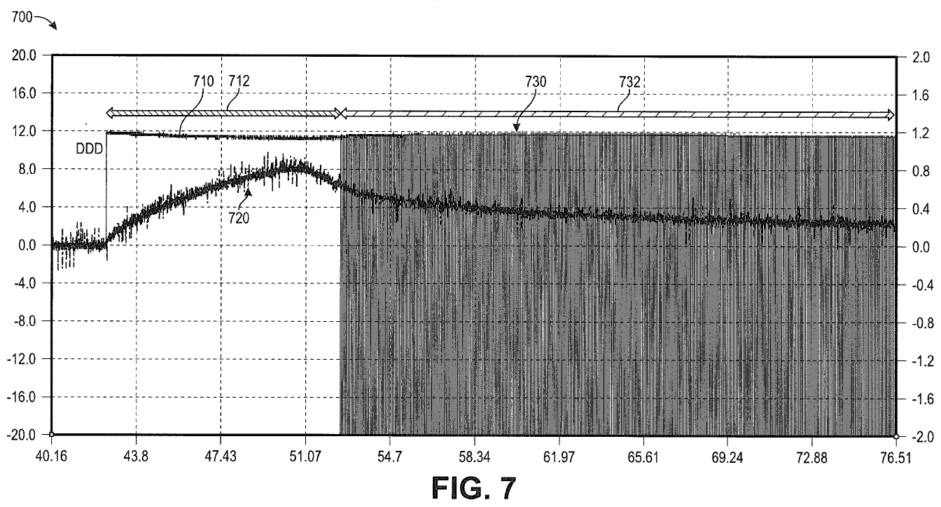

FIG. 7 illustrates a timing diagram 700 for signals of a PWM valve. The timing diagram 700 shows voltage on a left vertical axis, current (Amperes) on a right vertical axis, and time in milliseconds on a horizontal axis. An input electrical signal 710 with no PWM control is used to apply full current for a first period of time 712 to fully open a PWM valve (e.g., solenoid valve) of a valve and nozzle assembly. A controller having a PWM circuitry generates a PWM signal 730 having a duty cycle for a holding current (e.g., holding current for a holding current value is 70% to 75% of the full current value) that is less than the full current. Pulse Width Modulation (PWM) is a DC supply voltage that is switched on and off at a given frequency (e.g., 2 kHz, 20 kHz) for a modulated period of time (duty cycle). The frequency determines how fast the PWM completes a cycle and how fast a signal switches between high and low states. The duty cycle is the “on” time of the voltage and is expressed as a percentage of the time period. At 75% duty cycle the voltage is “on” for 75% of the time period and “off” for the remaining 25%. Therefore, the time averaged voltage is only 75% of the maximum supply voltage (e.g., 12 volt supply voltage) and the current to the solenoid is only 75% of maximum current as well. The PWM signal 730 applies the holding current for a second period of time 732 to hold the PWM valve fully open for the fluid application during the second period of time 732.

A current draw signal 720 (or power consumption signal 720) indicates current draw and power consumption of the PWM valve for the first period of time 712 and the second period of time 732. The power consumed in this example can be calculated by multiplying the square of average current, (IMAX x% duty cycle), by the coil resistance of the solenoid valve. The coil has an electrical charge that is slowly discharged when switching from the signal 710 with full current to the signal 730 with 75% duty cycle as indicated by the power consumption signal 720 slowly decreasing for about 20 milliseconds during the application of the signal 730.

The solenoid valve for FIG. 7 is drawing more current (and consuming more power) than necessary to keep the valve fully open for the initial 20 milliseconds of the second period of time 732.

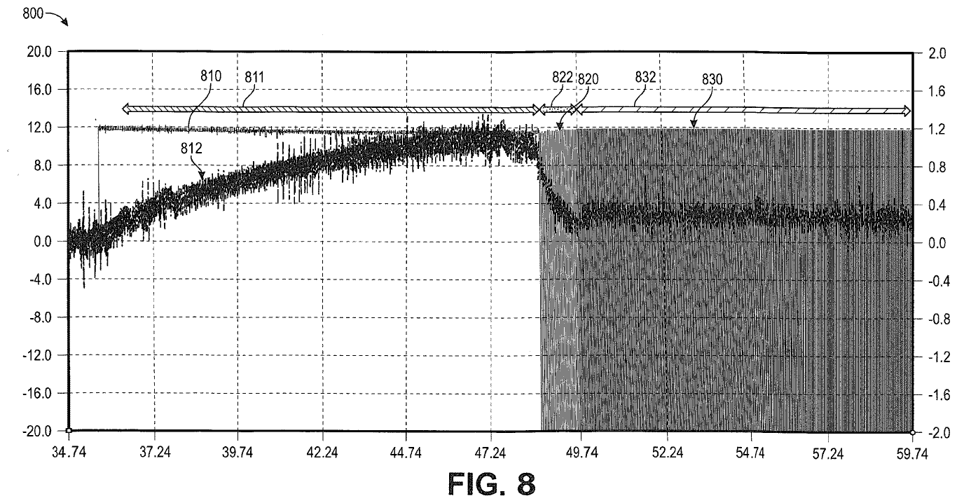

FIG. 8 illustrates a timing diagram 800 for signals of a PWM valve to reduce current draw and reduce power consumption in accordance with one embodiment. The timing diagram 800 shows voltage on a left vertical axis, current (Amperes) on a right vertical axis, and time in milliseconds on a horizontal axis. An input electrical signal 810 (e.g., 12 volt supply voltage) with no PWM control is used to apply full current for a first period of time 811 (e.g., 5 to 15 milliseconds depending on a fluid pressure for the fluid application) to fully open a PWM valve (e.g., solenoid valve). A controller having a PWM circuitry generates a PWM signal 820 having a duty cycle for a reduced current that is less than the full current. The PWM signal 820 having a series of pulses applies the reduced current for a reduced current value (e.g., reduced current value is from 0 up to a dissipating threshold value, reduced current value is 0 to 20% of a full current value, reduced current value is 5 to 15% of a full current value, reduced current value is approximately 8% to 12% of the full current value) that is below full current for a second period of time to rapidly dissipate energy in the PWM valve that is fully open. The reduced current has a low duty cycle for a brief time period to rapidly discharge the solenoid coil while still maintaining the valve in a fully open position. The rapid discharge of the solenoid coil is illustrated by the sharp negative slope of the current draw signal 812 (or power consumption signal 812) during the period of time 822. In one example, the second period of time is 0.20 milliseconds to 2.0 milliseconds. In another example, the second period of time is 1.0 milliseconds to 1.5 milliseconds.

A solenoid valve includes a solenoid and a valve body. The solenoid has an electromagnetically inductive coil around a moveable ferromagnetic core (plunger) in its center. In a closed position, the plunger closes off a small orifice in a body of the valve body. When electric current passes through the solenoid, the coil is energized and creates a magnetic field. This creates a magnetic attraction with the plunger, moving the plunger and overcoming a spring force. The magnetic field exerts an upward force on the plunger opening the orifice for an open position of the valve. Solenoid valves are used in a wide range of applications, with high or low pressures and small or large flow rates.

The controller having a PWM circuitry generates a PWM signal 830 having a duty cycle for a holding current (e.g., holding current for a holding current value is 70% to 80% of the full current value) that is less than the full current. The PWM signal 830 having a series of pulses applies holding current for a third period of time 832 to hold the PWM valve fully open for the fluid application. The current draw signal 812 (or power consumption signal 812) indicates current draw or power consumption of the PWM valve during the different time periods. The coil has an electrical charge that is rapidly discharged when switching from the signal 810 to the signal 820. The signal 812 rapidly decreases during the application of the signal 820 due to a low duty cycle (e.g., 0 to 20%, 5 to 15%, 10%, etc.) of the signal 820. PWM signals switch between high and low states at a given frequency (e.g., 2 kHz, 20 kHz) with the spectrum being broad for acceptable PWM signal frequencies.

The controller is able command different stages of PWM control including a first stage for the signal 820 and a second stage for the signal 830. The controller provides the commands to open the PWM valve as fast as possible, to rapidly dissipate energy in the PWM valve with the signal 820, and then generates the PWM signal 830 for a minimum holding current to simply hold the PWM valve open at a steady state. The signal 820 provides a near zero power condition for a brief period of time to drop power consumption nearly instantly to a minimum holding power to hold the PWM valve open for the fluid application.

FIG. 9 shows an example of a block diagram of an implement 140 (e.g., sprayer, spreader, irrigation implement, etc.) in accordance with one embodiment. The implement 140 includes a processing system 1200, memory 105, and a network interface 115 for communicating with other systems or devices. The network interface 115 can include at least one of a GPS transceiver, a WLAN transceiver (e.g., WiFi), an infrared transceiver, a Bluetooth transceiver, Ethernet, or other interfaces from communications with other devices and systems. The network interface 115 may be integrated with the implement network 150 or separate from the implement network 150 as illustrated in FIG. 9. The I/O ports 129 (e.g., diagnostic/on board diagnostic (OBD) port) enable communication with another data processing system or device (e.g., display devices, sensors, etc.).

In one example, the implement 140 is a self-propelled implement that performs operations for fluid applications of a field. Data associated with the fluid applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the network interface 115 or implement network 150. The communication unit 128 may be integrated with the processing system or separate from the processing system.

Processing logic 126 including one or more processors may process the communications received from the communication unit 128 including agricultural data (e.g., planting data, GPS data, fluid application data, flow rates, etc.). The system 1200 includes memory 105 for storing data and programs for execution (software 106) by the processing system. The memory 105 can store, for example, software components such as fluid application software for analysis of fluid applications for performing operations of the present disclosure, or any other software application or module, images (e.g., captured images of crops, images of a spray pattern for rows of crops), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 1200 communicates bi-directionally with memory 105, implement network 150, network interface 115, display device 130, display device 125, and I/O ports 129 via communication links 131-136, respectively.

Display devices 125 and 130 can provide visual user interfaces for a user or operator. The display devices may include display controllers. In one embodiment, the display device 125 is a portable tablet device or computing device with a touchscreen that displays data (e.g., PWM data for PWM valves, nozzle condition data, planting application data, fluid or fluid application data, captured images, localized view map layer, high definition field maps of as-applied fluid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 125 may be a display (e.g., display provided by an original equipment manufacturer (OEM)) that displays images and data for a localized view map layer, as-applied fluid or fluid application data, as-planted or as-harvested data, yield data, controlling an implement (e.g., planter, tractor, combine, sprayer, etc.), steering the implement, and monitoring the implement (e.g., planter, combine, sprayer, etc.). A cab control module 1270 may include an additional control module for enabling or disabling certain components or devices of the implement.

The implement 140 (e.g., planter, cultivator, plough, sprayer, spreader, irrigation, implement, etc.) includes an implement network 150 having multiple networks. The implement network 150 having multiple networks (e.g., Ethernet network, Power over Ethernet (PoE) network, a controller area network (CAN) serial bus protocol network, an ISOBUS network, etc.) may include a pump 156 for pumping fluid or fluid from a storage tank(s) 190 to row units of the implement, communication module 180 for receiving communications from controllers and sensors and transmitting these communications. In one example, the implement network 150 includes valve and nozzle assemblies 50, lights 60, and vision guidance system 71 having cameras and processors for various embodiments of this present disclosure.

Sensors 152 (e.g., speed sensors, seed sensors for detecting passage of seed, downforce sensors, actuator valves, OEM sensors, flow sensors, etc.), controllers 154 (e.g., drive system, GPS receiver), and the processing system 120 control and monitoring operations of the implement.

The OEM sensors may be moisture sensors or flow sensors, speed sensors for the implement, fluid application sensors for a sprayer, or vacuum, lift, lower sensors for an implement. For example, the controllers may include processors in communication with a plurality of sensors. The processors are configured to process data (e.g., fluid application data) and transmit processed data to the processing system 120. The controllers and sensors may be used for monitoring motors and drives on the implement.

FIG. 10 shows an example of a block diagram of a system 100 that includes a machine 102 (e.g., agricultural vehicle, tractor, combine harvester, etc.) and an implement 1240 (e.g., planter, cultivator, plough, sprayer, spreader, irrigation implement, etc.) in accordance with one embodiment. The machine 102 includes a processing system 1200, memory 105, machine network 110 that includes multiple networks (e.g., an Ethernet network, a network with a switched power line coupled with a communications channel (e.g., Power over Ethernet (PoE) network), a controller area network (CAN) serial bus protocol network, an ISOBUS network, etc.), and a network interface 115 for communicating with other systems or devices including the implement 1240. The machine network 110 includes sensors 112 (e.g., speed sensors), controllers 111 (e.g., GPS receiver, radar unit) for controlling and monitoring operations of the machine or implement. The network interface 115 can include at least one of a GPS transceiver, a WLAN transceiver (e.g., WiFi), an infrared transceiver, a Bluetooth transceiver, Ethernet, or other interfaces from communications with other devices and systems including the implement 1240. The network interface 115 may be integrated with the machine network 110 or separate from the machine network 110 as illustrated in FIG. 18. The I/O ports 129 (e.g., diagnostic/on board diagnostic (OBD) port) enable communication with another data processing system or device (e.g., display devices, sensors, etc.).

In one example, the machine is a self-propelled machine that performs operations of a tractor that is coupled to and tows an implement for planting or fluid applications of a field. Data associated with the planting or fluid applications can be displayed on at least one of the display devices 125 and 130.

The processing system 1200 may include one or more microprocessors, processors, a system on a chip (integrated circuit), or one or more microcontrollers. The processing system includes processing logic 126 for executing software instructions of one or more programs and a communication unit 128 (e.g., transmitter, transceiver) for transmitting and receiving communications from the machine via machine network 110 or network interface 115 or implement via implement network 150 or network interface 160. The communication unit 128 may be integrated with the processing system or separate from the processing system. In one embodiment, the communication unit 128 is in data communication with the machine network 110 and implement network 150 via a diagnostic/OBD port of the I/O ports 129 or via network devices 113a and 113b. A communication module 113 includes network devices 113a and 113b. The communication module 113 may be integrated with the communication unit 128 or a separate component.

Processing logic 126 including one or more processors may process the communications received from the communication unit 128 including agricultural data (e.g., planting data, GPS data, fluid application data, flow rates, etc.). The system 1200 includes memory 105 for storing data and programs for execution (software 106) by the processing system. The memory 105 can store, for example, software components such as planting application software for analysis of planting applications for performing operations of the present disclosure, or any other software application or module, images (e.g., captured images of crops), alerts, maps, etc. The memory 105 can be any known form of a machine readable non-transitory storage medium, such as semiconductor memory (e.g., flash; SRAM; DRAM; etc.) or non-volatile memory, such as hard disks or solid-state drive. The system can also include an audio input/output subsystem (not shown) which may include a microphone and a speaker for, for example, receiving and sending voice commands or for user authentication or authorization (e.g., biometrics).

The processing system 1200 communicates bi-directionally with memory 105, machine network 110, network interface 115, display device 130, display device 125, and I/O ports 129 via communication links 130-136, respectively.

Display devices 125 and 130 can provide visual user interfaces for a user or operator. The display devices may include display controllers. In one embodiment, the display device 125 is a portable tablet device or computing device with a touchscreen that displays data (e.g., PWM data for PWM valves, planting application data, fluid or fluid application data, captured images, localized view map layer, high definition field maps of as-applied fluid or fluid application data, as-planted or as-harvested data or other agricultural variables or parameters, yield maps, alerts, etc.) and data generated by an agricultural data analysis software application and receives input from the user or operator for an exploded view of a region of a field, monitoring and controlling field operations. The operations may include configuration of the machine or implement, reporting of data, control of the machine or implement including sensors and controllers, and storage of the data generated. The display device 1230 may be a display (e.g., display provided by an original equipment manufacturer (OEM)) that displays images and data for a localized view map layer, as-applied fluid or fluid application data, as-planted or as-harvested data, yield data, controlling a machine (e.g., planter, tractor, combine, sprayer, etc.), steering the machine, and monitoring the machine or an implement (e.g., planter, combine, sprayer, etc.) that is connected to the machine with sensors and controllers located on the machine or implement.

A cab control module 1270 may include an additional control module for enabling or disabling certain components or devices of the machine or implement. For example, if the user or operator is not able to control the machine or implement using one or more of the display devices, then the cab control module may include switches to shut down or turn off components or devices of the machine or implement.

The implement 1240 (e.g., planter, cultivator, plough, sprayer, spreader, irrigation, implement, etc.) includes an implement network 150 having multiple networks, a processing system 162 having processing logic 164, a network interface 160, and optional input/output ports 166 for communicating with other systems or devices including the machine 102. The implement network 150 having multiple networks (e.g., Ethernet network, Power over Ethernet (PoE) network, a controller area network (CAN) serial bus protocol network, an ISOBUS network, etc.) may include a pump 156 for pumping fluid or fluid from a storage tank(s) 190 to row units of the implement, communication modules (e.g., 180, 181) for receiving communications from controllers and sensors and transmitting these communications to the machine network. In one example, the communication modules include first and second network devices with network ports. A first network device with a port (e.g., CAN port) of communication module (CM) 180 receives a communication with data from controllers and sensors, this communication is translated or converted from a first protocol into a second protocol for a second network device (e.g., network device with a switched power line coupled with a communications channel, Ethernet), and the second protocol with data is transmitted from a second network port (e.g., Ethernet port) of CM 180 to a second network port of a second network device 113b of the machine network 110. A first network device 113a having first network ports (e.g., 1-4 CAN ports) transmits and receives communications from first network ports of the implement. In one example, the implement network 150 includes valve and nozzle assemblies 50, lights 60, vision guidance system 71 having cameras and processors, and autosteer controller 900 for various embodiments of this present disclosure. The autosteer controller 900 may also be part of the machine network 110 instead of being located on the implement network 150 or in addition to being located on the implement network 150.

Sensors 152 (e.g., speed sensors, seed sensors for detecting passage of seed, downforce sensors, actuator valves, OEM sensors, flow sensors, etc.), controllers 154 (e.g., drive system for seed meter, GPS receiver), and the processing system 162 control and monitoring operations of the implement.

The OEM sensors may be moisture sensors or flow sensors for a combine, speed sensors for the machine, seed force sensors for a planter, fluid application sensors for a sprayer, or vacuum, lift, lower sensors for an implement. For example, the controllers may include processors in communication with a plurality of seed sensors. The processors are configured to process data (e.g., fluid application data, seed sensor data) and transmit processed data to the processing system 162 or 1200. The controllers and sensors may be used for monitoring motors and drives on a planter including a variable rate drive system for changing plant populations. The controllers and sensors may also provide swath control to shut off individual rows or sections of the planter. The sensors and controllers may sense changes in an electric motor that controls each row of a planter individually. These sensors and controllers may sense seed delivery speeds in a seed tube for each row of a planter.

The network interface 160 can be a GPS transceiver, a WLAN transceiver (e.g., WiFi), an infrared transceiver, a Bluetooth transceiver, Ethernet, or other interfaces from communications with other devices and systems including the machine 102. The network interface 160 may be integrated with the implement network 150 or separate from the implement network 150 as illustrated in FIG. 10.

The processing system 162 communicates bi-directionally with the implement network 150, network interface 160, and I/O ports 166 via communication links 141-143, respectively. The implement communicates with the machine via wired and possibly also wireless bi-directional communications 104. The implement network 150 may communicate directly with the machine network 110 or via the network interfaces 115 and 160. The implement may also by physically coupled to the machine for agricultural operations (e.g., planting, harvesting, spraying, etc.). The memory 105 may be a machine-accessible non-transitory medium on which is stored one or more sets of instructions (e.g., software 106) embodying any one or more of the methodologies or functions described herein. The software 106 may also reside, completely or at least partially, within the memory 105 and/or within the processing system 1200 during execution thereof by the system 100, the memory and the processing system also constituting machine-accessible storage media. The software 1206 may further be transmitted or received over a network via the network interface 115.

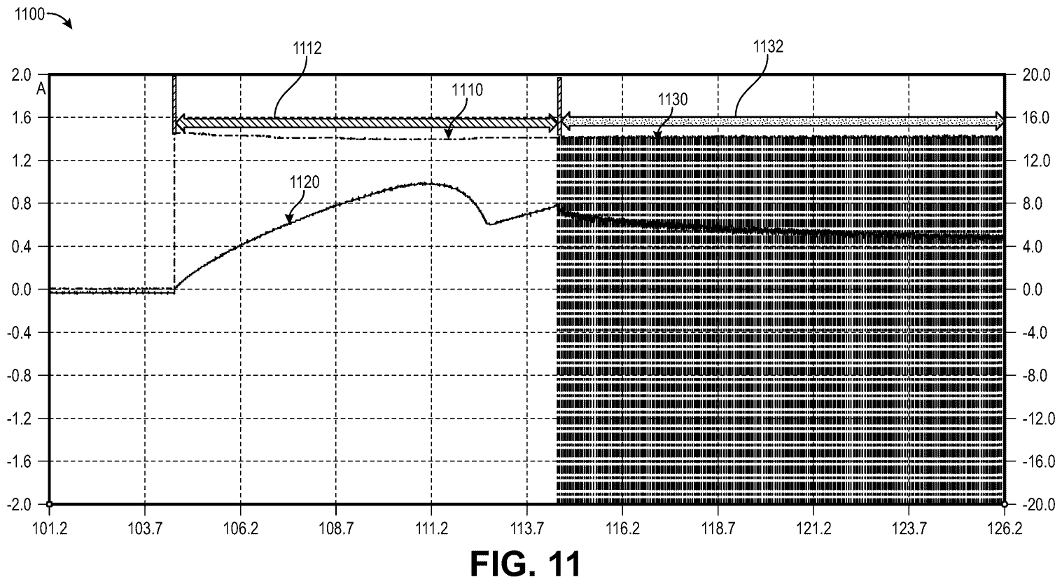

FIG. 11 illustrates a timing diagram 1100 for signals of a PWM valve. The timing diagram 1100 shows voltage on a right vertical axis, current (Amperes) on a left vertical axis, and time in milliseconds on a horizontal axis. An input electrical signal 1110 with no PWM control is used to apply full current for a first period of time 1112 to fully open a PWM valve (e.g., solenoid valve) of a valve and nozzle assembly. A controller having a PWM circuitry generates a PWM signal 1130 having a duty cycle for a holding current (e.g., holding current for a holding current value is 70% to 75% of the full current value) that is less than the full current. Pulse Width Modulation (PWM) is a DC supply voltage that is switched on and off at a given frequency (e.g., 2 kHz, 20 kHz) for a modulated period of time (duty cycle). The frequency determines how fast the PWM completes a cycle and how fast a signal switches between high and low states. The duty cycle is the “on” time of the voltage and is expressed as a percentage of the time period. At 75% duty cycle the voltage is “on” for 75% of the time period and “off” for the remaining 25%. Therefore, the time averaged voltage is only 75% of the maximum supply voltage (e.g., 12 volt supply voltage) and the current to the solenoid is only 75% of maximum current as well. The PWM signal 1130 applies the holding current for a second period of time 1132 to hold the PWM valve fully open for the fluid application during the second period of time 1132.

A current draw signal 1120 (or power consumption signal 1120) indicates current draw and power consumption of the PWM valve for the first period of time 1112 and the second period of time 1132. The power consumed in this example can be calculated by multiplying the square of average current, (IMAX x% duty cycle), by the coil resistance of the solenoid valve. The coil has an electrical charge that is slowly discharged when switching from the signal 1110 with full current to the signal 1130 with 75% duty cycle as indicated by the power consumption signal 1120 slowly decreasing during the application of the signal 1130.

The solenoid valve for FIG. 11 is drawing more current (and consuming more power) than necessary to keep the valve fully open for the second period of time 1132.

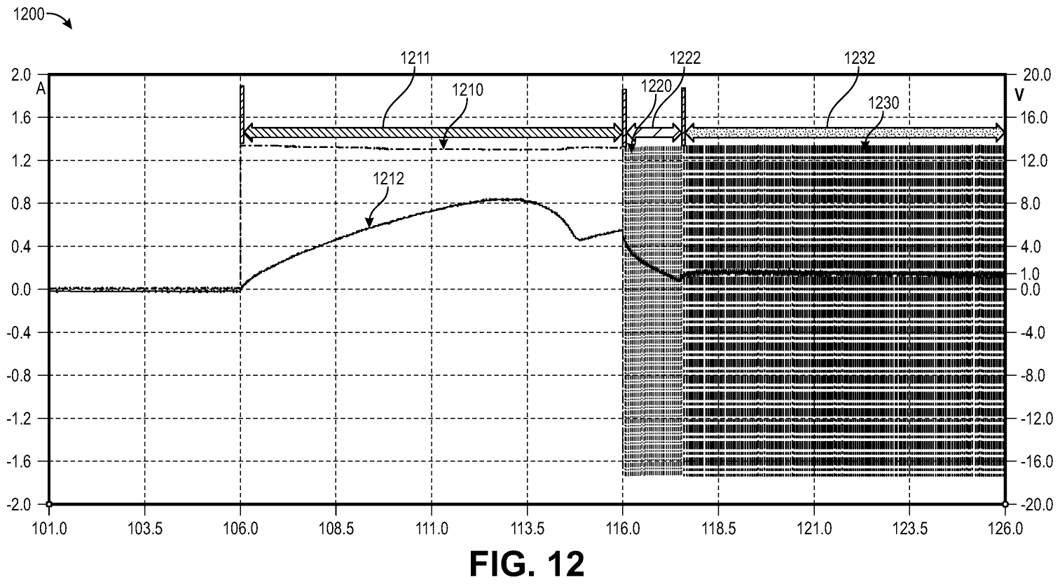

FIG. 12 illustrates a timing diagram 1200 for signals of a PWM valve to reduce current draw and reduce power consumption in accordance with one embodiment. The timing diagram 1200 shows voltage on a right vertical axis, current (Amperes) on a left vertical axis, and time in milliseconds on a horizontal axis. An input electrical signal 1210 (e.g., 12 volt supply voltage) with no PWM control is used to apply full current for a first period of time 1211 (e.g., 5 to 15 milliseconds depending on a fluid pressure for the fluid application) to fully open a PWM valve (e.g., solenoid valve). A controller having a PWM circuitry generates a PWM signal 1220 having a duty cycle for a reduced current that is less than the full current. The PWM signal 1220 having a series of pulses applies the reduced current for a reduced current value (e.g., reduced current value is from 0 up to a dissipating threshold value, reduced current value is 0 to 20% of a full current value, reduced current value is 5 to 15% of a full current value, reduced current value is approximately 8% to 12% of the full current value) that is below full current for a second period of time to rapidly dissipate energy in the PWM valve that is fully open. The reduced current has a low duty cycle for a brief time period to rapidly discharge the solenoid coil while still maintaining the valve in a fully open position. The rapid discharge of the solenoid coil is illustrated by the sharp negative slope of the current draw signal 1212 (or power consumption signal 1212) during the period of time 1222. In one example, the second period of time is 0.20 milliseconds to 2.0 milliseconds. In another example, the second period of time is 1.0 milliseconds to 1.5 milliseconds.

The controller having a PWM circuitry generates a PWM signal 1230 having a duty cycle for a holding current (e.g., holding current for a holding current value is 70% to 80% of the full current value) that is less than the full current. The PWM signal 1230 having a series of pulses applies holding current for a third period of time 1232 to hold the PWM valve fully open for the fluid application. The current draw signal 1212 (or power consumption signal 1212) indicates current draw or power consumption of the PWM valve during the different time periods. The coil has an electrical charge that is rapidly discharged when switching from the signal 1210 to the signal 1220. The signal 1212 rapidly decreases during the application of the signal 1220 due to a low duty cycle (e.g., 0 to 20%, 5 to 15%, 10%, etc.) of the signal 1220. PWM signals switch between high and low states at a given frequency (e.g., 2 kHz, 20 kHz) with the spectrum being broad for acceptable PWM signal frequencies.

The controller is able to command different stages of PWM control including a first stage for the signal 1220 and a second stage for the signal 1230. The controller provides the commands to open the PWM valve as fast as possible, to rapidly dissipate energy in the PWM valve with the signal 1220, and then generates the PWM signal 1230 for a minimum holding current to simply hold the PWM valve open at a steady state. The signal 1220 provides a near zero power condition for a brief period of time to drop power consumption nearly instantly to a minimum holding power to hold the PUM valve open for the fluid application.

### EXAMPLES

The following are non-limiting examples.
Example 1 is a method of operating a pulse width modulation (PWM) valve for a fluid application. The method includes applying full current for a first period of time to fully open the PWM valve, applying a reduced current for a reduced current value that is from 0 up to a dissipating threshold value that is below full current for a second period of time to rapidly dissipate energy in the PWM valve that is fully open, and applying a holding current for a third period of time to hold the PWM valve fully open for the fluid application.
Example 2—the method of Example 1, wherein the reduced current value is 0 to 20% of a full current value.
Example 3—the method of Example 1 or 2, wherein the reduced current value is 5% to 15% of the full current value.
Example 4—the method of Example 1 or 2, wherein the reduced current value is 8% to 12% of the full current value.
Example 5—the method of any preceding Example, wherein the second period of time is 0.20 milliseconds to 2.0 milliseconds.
Example 6—the method of any preceding Example, wherein the second period of time is 1.0 milliseconds to 1.5 milliseconds.
Example 7—the method of any preceding Example, wherein the holding current is designed as a minimum current to hold the PWM valve fully open for the fluid application.
Example 8—the method of any preceding Example, wherein the holding current for a holding current value is 70% to 80% of the full current value.
Example 9—the method of any preceding Example, further includes generating a first PWM signal having a first duty cycle for the reduced current and generating a second PWM signal having a second duty cycle for holding current.
Example 10—a fluid application system that includes a pulse width modulation (PWM) valve disposed on an implement and a controller coupled to the PWM valve. The controller is configured to apply full current for a first period of time to fully open the PWM valve, to apply a reduced current for a reduced current value that is from 0 up to a dissipating threshold value that is below full current for a second period of time to rapidly dissipate energy in the PWM valve that is fully open, and to apply a holding current for a third period of time to hold the PWM valve fully open for a fluid application to a field
Example 11—the fluid application system of Example 10, further includes additional PWM valves disposed along a boom of the implement or disposed on each row unit of the implement and a plurality of nozzles disposed along the boom of the implement or disposed on each row unit of the implement.
Example 12—the fluid application system of Example 11, wherein each nozzle is connected to or integrated with a PWM valve to spray the fluid application from each nozzle.
Example 13—the fluid application system of any of Examples 10 to 12, wherein the reduced current value is 0 to 20% of a full current value.
Example 14—the fluid application system of any of Examples 10 to 12, wherein the reduced current value is 5% to 15% of the full current value.
Example 15—the fluid application system of any of Examples 10 to 12, wherein the reduced current value is 8% to 12% of the full current value.
Example 16—the fluid application system of any of Examples 10 to 15, wherein the second period of time is 0.20 milliseconds to 2.0 milliseconds.
Example 17—the fluid application system of any of Examples 10 to 15, wherein the second period of time is 1.0 milliseconds to 1.5 milliseconds.
Example 18—the fluid application system of of any of Examples 10 to 17, wherein the holding current is designed as a minimum current to hold the PWM valve fully open for the fluid application.
Example 19—the fluid application system of any of Examples 10 to 18, wherein the holding current for a holding current value is 70% to 80% of the full current value.
Example 20—the fluid application system of any of Examples 10 to 19, wherein the controller is further configured to generate a first PWM signal having a first duty cycle for the reduced current and to generate a second PWM signal having a second duty cycle for the holding current.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

The foregoing description is presented to enable one of ordinary skill in the art to make and use embodiments of the invention and is provided in the context of a patent application and its requirements. Various modifications to the preferred embodiment of the apparatus, and the general principles and features of the system and methods described herein will be readily apparent to those of skill in the art. Thus, the present disclosure is not to be limited to the embodiments of the apparatus, system and methods described above and illustrated in the drawing figures, but is to be accorded the widest scope consistent with the spirit and scope of the appended claims.

1. A method of operating a pulse width modulation (PWM) valve for a fluid application comprising:
applying full current for a first period of time to fully open the PWM valve;
applying a reduced current for a reduced current value that is from 0 up to a dissipating threshold value that is below full current for a second period of time to rapidly dissipate energy and minimize power consumption of the PWM valve that is fully open for the second period of time; and
applying a holding current for a third period of time to hold the PWM valve fully open for the fluid application.

2. The method of claim 1, wherein the reduced current value is 0 to 20% of a full current value.

3. The method of claim 1, wherein the reduced current value is 5% to 15% of the full current value.

4. The method of claim 1, wherein the reduced current value is 8% to 12% of the full current value.

5. The method of claim 1, wherein the second period of time is 0.20 milliseconds to 2.0 milliseconds.

6. The method of claim 1, wherein the second period of time is 1.0 milliseconds to 1.5 milliseconds.

7. The method of claim 1, wherein the holding current is designed as a minimum current to hold the PWM valve fully open for the fluid application.

8. The method of claim 1, wherein the holding current for a holding current value is 70% to 80% of the full current value.

9. The method of claim 1, further comprising:
generating a first PWM signal having a first duty cycle for the reduced current; and
generating a second PWM signal having a second duty cycle for the holding current.

10. A fluid application system comprising:
a pulse width modulation (PWM) valve disposed on an implement; and
a controller coupled to the PWM valve, wherein the controller is configured to apply full current for a first period of time to fully open the PWM valve, to apply a reduced current for a reduced current value that is from 0 up to a dissipating threshold value that is below full current for a second period of time to rapidly dissipate energy in the PWM valve that is fully open, and to apply a holding current for a third period of time to hold the PWM valve fully open for a fluid application to a field.

11. The fluid application system of claim 10 further comprising:
additional PWM valves disposed along a boom of the implement or disposed on each row unit of the implement; and
a plurality of nozzles disposed along the boom of the implement or disposed on each row unit of the implement.

12. The fluid application system of claim 11, wherein each nozzle is connected to or integrated with a PWM valve to spray the fluid application from each nozzle.

13. The fluid application system of claim 10, wherein the reduced current value is 0 to 20% of a full current value.

14. The fluid application system of claim 10, wherein the reduced current value is 5% to 15% of the full current value.

15. The fluid application system of claim 10, wherein the reduced current value is 8% to 12% of the full current value.

16. The fluid application system of claim 10, wherein the second period of time is 0.20 milliseconds to 2.0 milliseconds.

17. The fluid application system of claim 10, wherein the second period of time is 1.0 milliseconds to 1.5 milliseconds.

18. The fluid application system of claim 10, wherein the holding current is designed as a minimum current to hold the PWM valve fully open for the fluid application.

19. The fluid application system of claim 10, wherein the holding current for a holding current value is 70% to 80% of the full current value.

20. The fluid application system of claim 10, wherein the controller is further configured to generate a first PWM signal having a first duty cycle for the reduced current and to generate a second PWM signal having a second duty cycle for the holding current.
